(19) United States
(12) Patent Application Publication
(10) Pub. No.: US 2008/0180224 A1
(43) Pub. Date: Jul. 31, 2008

(54) APPARATUS AND METHOD FOR PROVIDING A SUPPLY VOLTAGE AND A LOAD MODULATION IN A TRANSPONDER

(75) Inventors: Christian Klapf, Graz (AT); Guenter Hofer, St. Oswald (AT); Walter Kargl, Graz (AT); Albert Missoni, Graz (AT); Gerald Holweg, Graz (AT)

Correspondence Address: DICKSTEIN SHAPIRO LLP, 1177 AVENUE OF THE AMERICAS 6TH AVENUE, NEW YORK, NY, 10036-2714, US

(73) Assignees: INFINEON TECHNOLOGIES AG, Munich (DE); Technische Universitaet Graz, Graz (AT)

(21) Appl. No.: 11/674,897

(22) Filed: Feb. 14, 2007

(30) Foreign Application Priority Data
Jan. 31, 2007 (DE) 10 2007 004 843.4

(51) Int. Cl. H04B 1/59

(52) U.S. Cl. 340/10.4; 327/538; 327/540

(57) ABSTRACT

A device for providing a supply voltage and a load modulation in a transponder with a unit having a resistance controllable by a control signal at a control input thereof, a unit for applying a load modulation signal to the control input, and a unit for applying a voltage limitation control signal to the control input.

### CROSS-REFERENCE TO RELATED APPLICATION

This application claims priority from German Patent Application No. 10 2007 004 843.4, which was filed on Jan. 31, 2007, and is incorporated herein by reference in its entirety.

### BACKGROUND

The present invention relates to an apparatus and method for providing a supply voltage and a load modulation in a transponder, as it may particularly be used in an RFID transponder (RFID=radio frequency identification).

So-called RFID technology has been used for some time, among other things, in the area of automatic identification of products, persons, goods and animals. RFID technology is a radio-based, contactless identification method which originally used radio frequencies in the radio frequency range (100 kHz to some 10 MHz), wherein, however, there are now used frequencies down to the microwave range. Advantages of these systems, for example as compared to barcode systems, are, among other things, a significantly higher capacitance, robustness with respect to environmental influences and contamination, significantly larger ranges and the possibility of reading out many transponders (composed of transmitter and responder) at the same time.

A transponder is the actual label which carries information, for example of a product, and communicates with a stationary or mobile reader and/or transceiver. Depending on the system structure, this communication allows reading and writing to the transponder, thus resulting in additional flexibility of the system. A later alteration of product data is thus easily possible. A further advantage of RFID systems is the possibility of using passive transponders that are operable without their own energy supply and may thus be built in a correspondingly compact form.

An RFID system typically consists of one or more readers and a plurality of transponders. The reader and the transponder each have an antenna which significantly influences a range of communication between the reader and the transponder. If the transponder gets in the proximity of the antenna of the reader, both (transponder and reader) exchange data. In addition to the data, the reader also transmits energy to the transponder. For this purpose, there is an antenna coil in the interior of the transponder, which is, for example, implemented as a frame or ferrite antenna. For the operation of the transponder, the reader first generates a high-frequency magnetic alternating field by means of its antenna. The antenna also includes a large-area coil with several turns. If the transponder is held in the proximity of the reader antenna, the field of the reader generates an induction voltage in the coil of the transponder. This induction voltage is rectified and serves for the voltage supply of the transponder. In general, a capacitance C₂ is connected in parallel to an inductance L₂ of the transponder coil. This results in a parallel oscillating circuit. The resonant frequency of this oscillating circuit corresponds to the transmission frequency of the RFID system. At the same time, the antenna coil of the reader is also brought into resonance by an additional capacitor in series or parallel connection.

The voltage induced in the transponder coil very quickly reaches high values by resonance rise in the parallel oscillating circuit. If, for example, a coupling factor between the reader and the transponder is increased, for example by reducing the distance between the reader and the transponder, or if a value of a load resistor R_{L} in parallel to the parallel oscillating circuit is increased, a voltage of far more than 100 volts may be achieved. However, for operating a data carrier and/or an integrated circuit in an RFID transponder, only a constant supply voltage of, for example, 3 to 5 volts (after rectification) is generally required. In order to control the supply voltage independent of the coupling factor or other parameters and to keep it constant, a voltage-dependent shunt resistor R_{S} may be connected in parallel to the load resistor R_{L}, for example. With increasing induction voltage Uᵢ, a value of the shunt resistor R_{S} assumes smaller and smaller values and thus reduces the quality of the transponder oscillating circuit exactly so much that the supply voltage remains at least approximately constant.

In addition, a clock frequency is derived from the alternating voltage induced in the transponder and/or from the supply voltage regulated by the shunt resistor, wherein the clock frequency is then available to a memory chip or a microprocessor of the transponder as system clock. In the simplest case, the data transmission from the reader to the transponder is effected by so-called amplitude shift keying, in which the high-frequency magnetic alternating field is switched on and off. The reverse data transmission from the transponder to the reader uses, for example, the properties of the transformation coupling between the reader antenna and the transponder antenna. The reader antenna provides a primary coil with an inductance L₁, and the transponder coil provides a secondary coil with an inductance L₂ of a transformer formed of the reader antenna and the transponder antenna. By altering circuit parameters of the transponder oscillating circuit in the clock of a data stream, the magnitude and phase of a transformed transponder impedance are influenced so that, by suitable evaluation in the reader, the data sent by the transponder may be reconstructed. For this purpose, a parallel resistor R_{mod} in parallel to the load resistor R_{L} of the data carrier may be switched on and off according to the clock of a data stream in the data carrier of the transponder.

The control of the shunt resistor R_{S} depending on the induced voltage and the switching of the parallel resistor R_{mod} are typically performed via two separate transistors.

As integrated RFID circuits are becoming smaller and smaller, it is desirable to realize the control of the shunt resistor R_{S} and the switching of the modulation resistor R_{mod} via a single transistor.

### BRIEF SUMMARY

According to embodiments, the present invention provides a device for providing a supply voltage and a load modulation in a transponder with a means having a resistance controllable by a control signal at a control input thereof, a means for applying a load modulation signal to the control input and a means for applying a voltage limitation control signal to the control input.

### BRIEF DESCRIPTION OF THE DRAWINGS

Preferred embodiments of the present invention will be explained in more detail below with reference to the accompanying drawings, in which:

FIG. 1 shows a functional principle of a voltage regulation and a load modulation in a transponder;

FIG. 2 shows a schematic block circuit diagram for illustrating a conventional realization of voltage regulation and load modulation;

FIG. 3 shows a schematic block circuit diagram for illustrating the inventive concept;

FIG. 4 shows a schematic block circuit diagram of a first embodiment of the present invention;

FIG. 5a shows a schematic circuit diagram of a second embodiment of the present invention;

FIG. 5b shows a schematic circuit diagram of a third embodiment of the present invention;

FIG. 6 shows a schematic circuit diagram of a further embodiment of the present invention; and

FIG. 7 shows a flow diagram for illustrating a method according to an embodiment of the present invention.

### DETAILED DESCRIPTION

With respect to the following description, it is to be noted that, in the various embodiments, equal functional elements or those operating in the same way have the same reference numerals, and thus the descriptions of these functional elements are interchangeable in the various embodiments illustrated in the following.

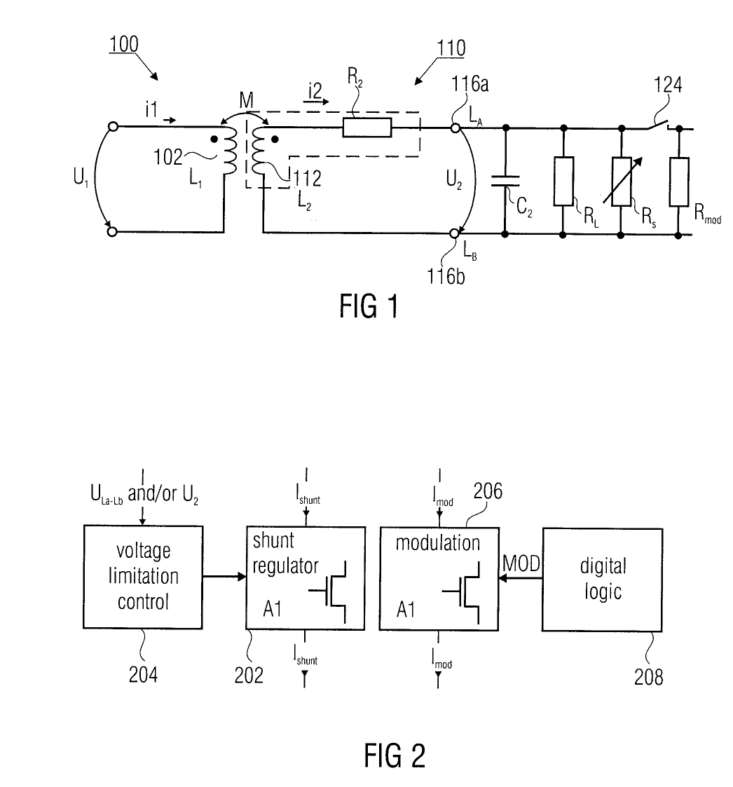

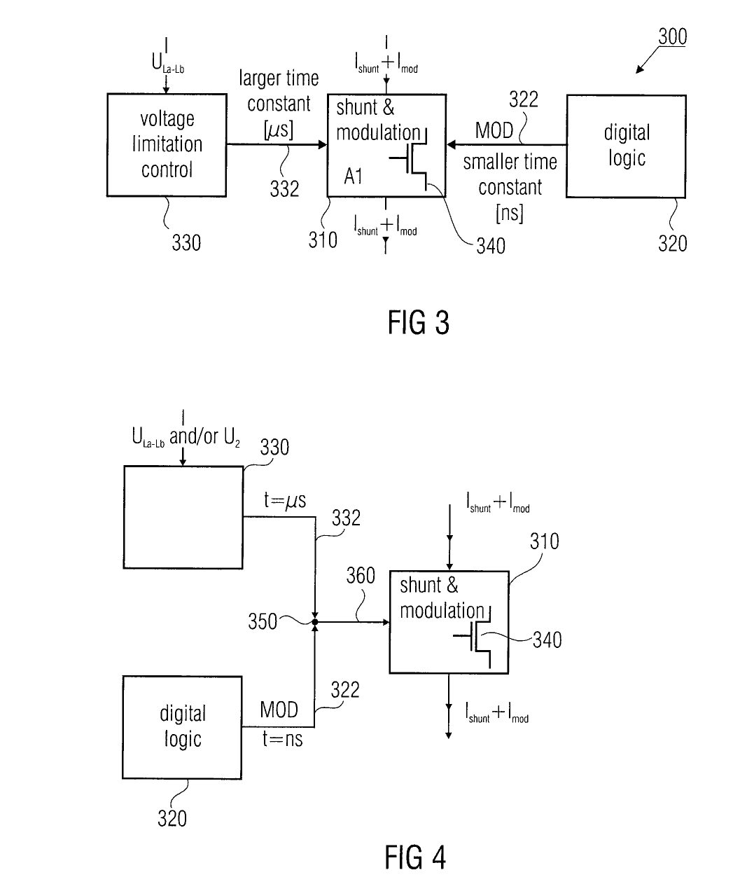

Before the inventive concept and embodiments of the present invention will be explained in more detail with reference to FIGS. 3 to 7, the functional principle of voltage regulation and load modulation in a transponder will be explained below based on FIGS. 1 and 2.

FIG. 1 shows an equivalent circuit diagram of a magnetic coupling between a reader 100 with a reader coil 102 having an inductance L₁ and a transponder 110 with a transmission/reception coil 112 having an inductance L₂ and winding resistor R₂.

The inductance L₂ of the transponder coil 112 is coupled to a first terminal of the resistor R₂ via a first terminal. A second terminal of the resistor R₂ forms a first clamp/terminal 116a, a second terminal of the inductance L₂ forms a second clamp/terminal 116b of the transponder coil 112. A voltage U₂ may be tapped between the clamps 116a and 116b.

Furthermore, the equivalent circuit illustrated in FIG. 1 has a capacitance C₂ between the clamps 116a and 116b on the transponder 110 side, a resistor R_{L} representing a load in parallel thereto, a controllable, voltage-dependent shunt resistor R_{S} in parallel thereto and again in parallel thereto a modulation resistor R_{mod} controllable via a switch 124.

A time-variable magnetic flow through the reader coil 102 induces a voltage by mutual inductance M in the transponder coil 112, thus creating an additional voltage drop by a current flow through the winding resistor R₂, so that the voltage U₂ may be tapped at the clamps 116a, 116b. The voltage U₂ induced at the transponder coil 112 is generally used for the voltage supply of a data memory and/or microchip of the passive transponder 110. In order to improve the efficiency, a parallel oscillating circuit is formed by connecting the additional capacitance C₂ in parallel to the transponder coil 112, the resonant frequency of the parallel oscillating circuit generally corresponding to the operating frequency of the respective RFID system, which may, for example, have a frequency of 125 kHz or 13.56 MHz or also any other frequency suitable for RFID systems.

In the case of passive transponders, the supply voltage of the data carrier is obtained from the voltage U₂. For this purpose, the voltage U₂ may, for example, be transformed to direct voltage and smoothed by means of a bridge rectifier. The voltage U₂ induced in the transponder coil 112 may very quickly reach high values by a resonance rise in the oscillating circuit formed of transponder coil 112 and capacitance C₂. If, for example, the coupling factor between the primary coil 102 and the secondary transponder coil 112 is increased, for example by reducing the distance between the reader 100 and the transponder 110, or if the value of the load resistor R_{L} is increased, a voltage U₂ of far more than 100 volts may be achieved. However, a constant operating voltage of about 3V to 5V is required for the operation of a microchip in the transponder 110. In order to regulate and/or control the voltage U₂ independent of the coupling factor or other parameters and to keep it constant, a voltage-dependent shunt resistor R_{S} is generally used which is connected in parallel to the load resistor R_{L}.

With increasing induction voltage at the transponder coil 112, the value R_{S} of the shunt resistor assumes smaller and smaller values and thus reduces the quality of the transponder oscillating circuit exactly so much that the voltage U₂ at the clamps 116a,b remains at least approximately constant. In the case of, for example, an increasing coupling factor k, the voltage U₂ first increases. When using an “ideal” shunt regulator, the value R_{S} of the shunt resistor starts to decrease in an inversely proportional way with respect to the coupling factor k, after reaching a target value of U₂ for a supply voltage of a microchip, such that the voltage U₂ remains constant at the clamps 116a,b.

As already mentioned in the beginning, load modulation is a frequent method for RFID, which is used for data transmission from the transponder 110 to the reader 100. For a so-called ohmic load modulation, the parallel resistor R_{mod} is switched on and off according to the clock of a data stream or according to the clock of a modulated auxiliary carrier in the microchip of the transponder 110. The parallel connection of R_{mod} results in a smaller overall resistance, whereby the Q-factor and thus also a so-called transformed transponder impedance become smaller in magnitude. The transformed transponder impedance is an imaginary impedance in a series resonant circuit of the reader 100. That is, when there is mutual inductance M, the reader 100 electrically behaves as if the imaginary transponder impedance were really present as a discrete device in the series resonant circuit of winding resistor, inductance L₁, etc. Switching the modulation resistor R_{mod} on and off generates an amplitude modulation at the reader coil 102, whereby data may be transmitted from the transponder 110 to the reader 100.

In the case of conventional RFID transponders, a regulation and/or control of the shunt resistor R_{S} and the connection of the modulation resistor 126 R_{mod} is respectively performed by means of a separate transistor. This aspect is schematically shown in the block circuit diagram in FIG. 2.

FIG. 2 shows a first means 202 for controlling the shunt resistor R_{S}, which is coupled to a means 204 for applying a voltage limitation control signal to the means 202. FIG. 2 further shows a means 206 for switching the modulation resistor R_{mod}, which is coupled to a logic circuit 208.

The means 202 serves for limiting the induced voltage U₂ at the clamps 116a,b to a limited supply voltage U₂ of some volts. For this purpose, the means 202 generally comprises a transistor, to the control terminal of which the voltage limitation control signal is supplied and whose resistance of the drain-source and/or collector-emitter path acts as a shunt resistor R_{S}. Thus, the shunt resistor R_{S} and thus also U₂ may be controlled with the voltage limitation control signal.

The means 206 serves for switching the modulation resistor R_{mod} according to the clock of a data stream provided by the means 208, for example a microchip. For this purpose, the means 206 generally comprises a further transistor to the control terminal of which a load modulation signal is supplied and whose resistance of the drain-source and/or collector-emitter path acts as a modulation resistor R_{mod}.

In general, RFID transponders are becoming smaller and smaller. In order to save chip area, it is desirable to use only one transistor for both tasks, the supply voltage limitation by the shunt resistor R_{S} and the load modulation by means of R_{mod}.

Embodiments of the present invention provide a device for providing a supply voltage and a load modulation in a transponder, as it is schematically shown in FIG. 3.

FIG. 3 shows a schematic block circuit diagram of a device 300 for providing a supply voltage and a load modulation in a transponder according to an embodiment of the present invention.

The device 300 comprises a means 310 having a resistance controllable by a control signal at a control input of the means 310. Furthermore, the device 300 includes means 320 for applying a load modulation signal 322 to the control input of the means 310. Furthermore, the device 300 for providing a supply voltage and a load modulation includes means 330 for applying a voltage limitation control signal 332 to the control input of the means 310.

According to embodiments of the present invention, the means 310 with the controllable resistance comprises a transistor 340. It may, for example, be a bipolar transistor or a CMOS transistor. The inventive concept thus uses only one transistor 340 which performs both the control of the supply voltage for a transponder from the induced voltage at the transponder coil 112 and the switching of the modulation resistor R_{mod} for the load modulation.

For this purpose, the two control signals 322 and 332 may have different time constants. Here, time constant means, for example, the period of time in which an exponentially decreasing signal decreases to 1/e (about 36.8%) of its starting value. According to embodiments, the voltage limitation control signal 332 comprises a larger time constant than the load modulation signal 322. The time constant of the voltage limitation control signal 332 is typically in a range of some microseconds (μs), whereas the time constant of the load modulation signal 322 is typically in a range of some nanoseconds (ns). A supply voltage controlled and/or regulated by the voltage limitation control signal 332 may thus be modulated by the higher-frequency load modulation signal 322.

According to embodiments, the means 320 for applying the load modulation signal 322 corresponds to an integrated circuit, particularly an integrated logic circuit, such as a microchip and/or microcontroller.

The means 330 for applying the voltage limitation control signal 332 may, for example, include a Zener diode and/or Z-diode connected between the control terminal of the transistor 340 and the clamp 116a. The source terminal of the transistor 340 is, for example, coupled to the clamp 116b, whereas the drain and/or collector terminal of the transistor 340 may be coupled to the clamp 116a. Via the signal present at the control terminal of the transistor 340, the transistor resistance of the drain-source path and/or the collector-emitter path of the transistor 340 may now be controlled, wherein the transistor resistance in this context acts as a shunt resistor. If the induced voltage U₂ between the clamps 116a,b increases to exceed a predefined value, the Zener diode between the clamp 116a and the control terminal of the transistor 340 operates in the breakdown range and the transistor 340 is connected through. Thus, the voltage U₂ present at the clamps 116a,b may be limited to the predefined value.

According to further embodiments, the means 330 for applying the voltage limitation control signal 332 includes a differential amplifier to compare the voltage U₂ to be regulated to the predefined value with the predefined value and to provide the voltage limitation control signal 332 depending on the difference.

By controlling the controllable resistance, i.e. the transistor resistance, a control of the quality of the transmission/reception oscillating circuit of a transponder is thus performed to keep the supply voltage U₂ in a predefined supply voltage range. For this purpose, the means 330 for applying the voltage limitation control signal 332 may include a control or regulating circuit according to embodiments.

In addition to the voltage limitation control signal 332, the load modulation signal 322 of the digital logic circuit 320 is applied to the control input of the transistor 340. If the load modulation signal 322 corresponds to a logical “1”, the control signal of the transistor 340, which is influenced by the voltage limitation control signal 332, is, for example, further increased, whereby the gate-source resistance of the transistor 340 may be further reduced. This means that the transistor resistance additionally acts as a modulation resistor in this context. A voltage U₂ already limited to a predefined limitation value by the voltage limitation control signal 332 may thus be further reduced by the load modulation signal 322 to obtain a load modulation.

If, however, the load modulation signal 322 carries a logical “0”, a signal level corresponding to the voltage limitation control signal 332 is, for example, present at the control input of the transistor 340, i.e., in the case of a voltage limitation of U₂, the voltage U₂ has at least approximately the predefined limitation value.

According to embodiments, the voltage limitation control signal 332 and/or the load modulation signal 322 may be both a voltage and a current.

According to embodiments of the present invention, the load modulation signal 322 and the voltage limitation control signal 332 are thus added to yield an overall control signal at the control input of the transistor 340 by combining them, for example, by means of a circuit node, as it is schematically shown in FIG. 4.

The load modulation signal 322 of the integrated logic circuit 320 and the voltage limitation control signal 332 of the means 330 for applying the voltage limitation control signal 332 are combined outside the means 310 with the controllable resistance via a node 350 to form an overall control signal 360. The overall control signal 360 is present at the control input of the transistor 340. According to embodiments, the node 350 may also be within the means 310 with the controllable resistance.

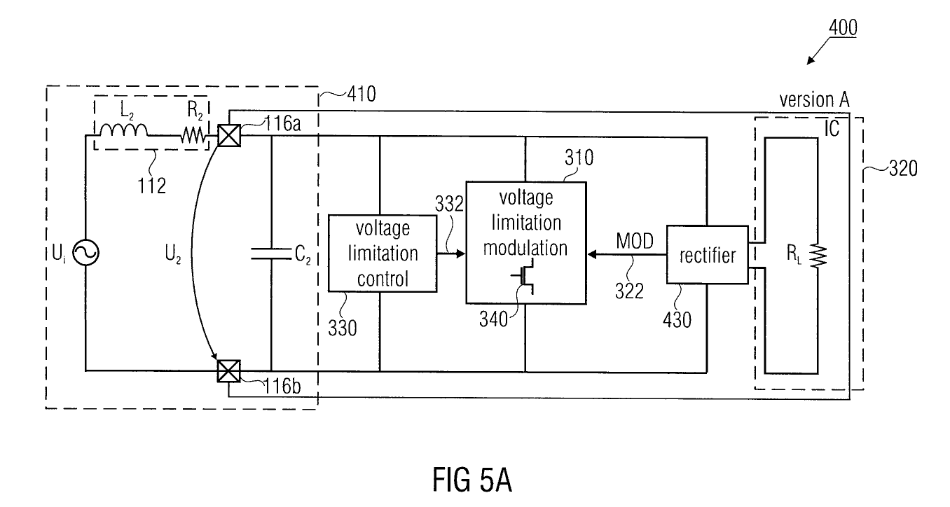

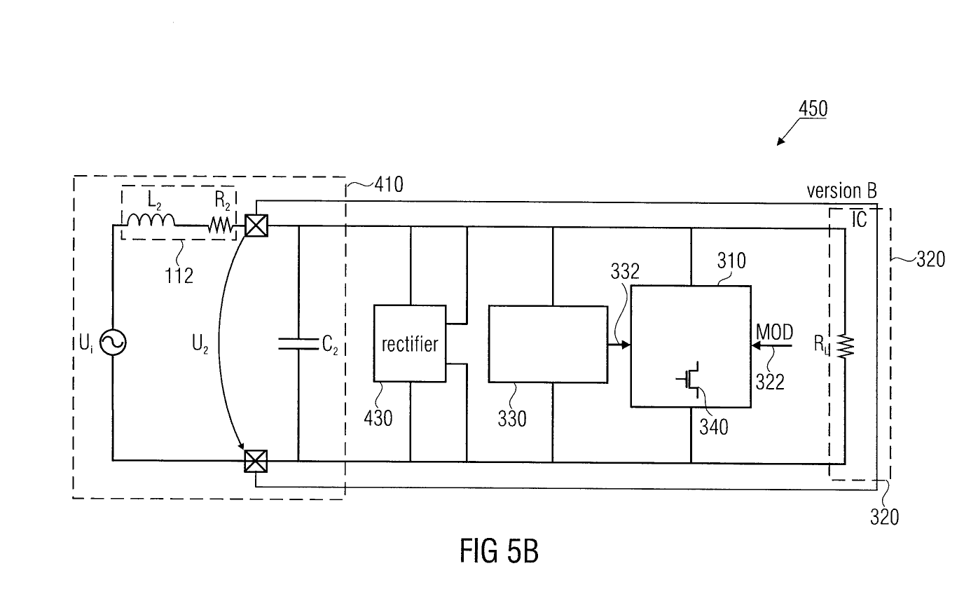

In order to supply an RFID transponder with energy, a direct voltage is generally required. According to embodiments, the device 300 for providing the supply voltage and the load modulation thus further comprises means for rectifying the supply voltage, as shown in FIGS. 5a and 5b.

FIG. 5a shows a transponder circuit 400 comprising a transmission/reception oscillating circuit 410, an integrated circuit, represented by the load resistor R_{L}, a transistor 340 and a voltage limitation control and/or regulating circuit 330. Furthermore, the transponder circuit comprises a rectifying circuit 430. The transmission/reception oscillating circuit 410 includes a coil 112 having an inductance L₂ and a winding resistor R₂ and a capacitance C₂ connected in parallel to the coil 112, wherein the coil 112 and the capacitance C₂ are connected between clamps 116a and 116b. A voltage Uᵢ is induced at the coil 112, which results in a voltage U₂ at the clamps 116a,b. The voltage limitation control circuit 330 is connected in parallel to the capacitance C₂ between the clamps 116a,b, so that the voltage limitation control circuit 330 is coupled to the transmission/reception coil 112 via the clamps 116a,b. The voltage limitation control circuit 330 comprises an output for a voltage limitation control signal 332 coupled to the control input of the transistor 340 connected between the clamps 116a,b. The control input of the transistor 340 is further coupled to an output for a modulation signal 322 of the integrated circuit represented by the load resistor R_{L}.

Between the transistor 340 and the integrated circuit, the rectifier 430 is further connected between the clamps 116a,b to supply the integrated circuit and/or a microchip with the supply voltage U₂ regulated by the transistor 340 and rectified by the rectifier 430.

As described above, in the embodiment shown in FIG. 5a, the limitation of the supply voltage U₂ and the load modulation is achieved by additive superposition of the voltage limitation control signal 332 and the load modulation signal 322 at the control input of the transistor 340.

A further embodiment of the present invention is illustrated in FIG. 5b. FIG. 5b shows a transponder circuit 450 comprising a transmission/reception oscillating circuit 410, a rectifier 430 connected in parallel thereto, a voltage limitation control circuit 330, a transistor 340 and an integrated circuit 320.

Compared to the embodiment shown in FIG. 5a, in which an already limited supply voltage U₂ is rectified by the rectifier 430, in the embodiment shown in FIG. 5b, the voltage U₂ applied to the clamps 116a,b by the induced voltage Uᵢ is rectified and only subsequently supplied to the limitation and load modulation mechanism by the voltage limitation control circuit 330, the transistor 340 and the modulation signal 322 provided by the integrated circuit represented by the load resistor R_{L}.

According to further embodiments, the present invention provides a transponder circuit with a transmission/reception coil, an integrated circuit coupled to the transmission/reception coil and comprising an output for a modulation signal, a transistor coupled to the transmission/reception coil and comprising a control input coupled to the output for the modulation signal, and a voltage limitation control circuit coupled to the transmission/reception coil and comprising an output for a voltage limitation control signal coupled to the control input of the transistor.

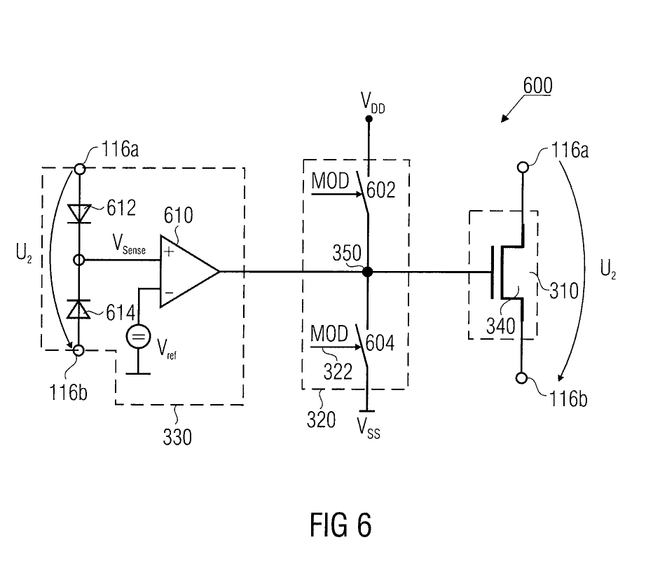

A further embodiment of the present invention is shown in FIG. 6 in the form of a schematic circuit diagram.

FIG. 6 shows a part of a transponder circuit 600 with means 310 having a controllable resistance, which comprises an NMOS transistor 340 connected between clamps 116a,b, means 320 for applying a load modulation signal 322 having two switches 602, 604, and a voltage limitation control circuit 330 comprising a differential amplifier 610 and two diodes 612, 614 connected in an opposite way.

Via the two diodes 612 and 614 connected in an opposite way, the induced alternating voltage U₂ present at the clamps 116a,b is rectified. The induced, rectified voltage U₂, i.e. Vₛₑₙₛₑ, is supplied to the non-inverting input of the differential amplifier 610 to provide a control potential for the transistor 340 depending on a difference between Vₛₑₙₛₑ and a suitable reference voltage V_{ref} present at the inverting input of the differential amplifier 610, for example provided by a bandgap circuit or a voltage divider. If U₂ increases in magnitude, the difference between Vₛₑₙₛₑ and V_{ref} increases and thus the control potential of the transistor 340 increases, for example in the absence of a modulation signal 322 (i.e. both switches 602, 604 are open). The transistor 340 assumes a low resistance and thus limits the voltage U₂ between the clamps 116a,b.

In the case of an applied modulation signal 322 with a logical “1”, the switch 604 is closed and the switch 602 is opened. The potential at the node 350 is thus “pulled down”. Thus, the voltage U₂ between the clamps 116a,b is increased for a short time. The opposite is the case with an applied modulation signal 322 with a logical “0”. The means 320 for applying the load modulation signal 322 thus “overdrives” the voltage limiter circuit.

The two switches 602 and 604 may be realized by transistors, particularly PMOS and NMOS transistors. Furthermore, the modulated voltage may also be limited according to embodiments.

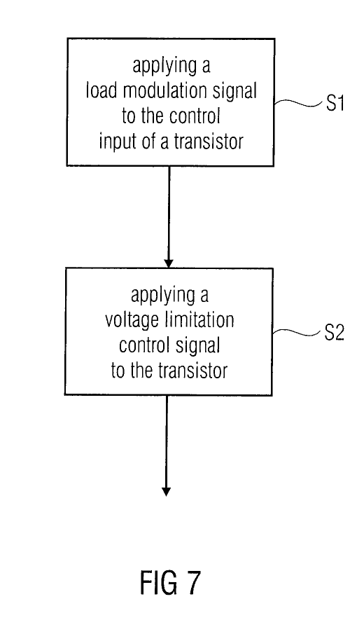

Furthermore, the present invention provides a method for providing a supply voltage and a load modulation in a transponder, as it is schematically shown in the flow diagram in FIG. 7.

According to embodiments, the method for providing a supply voltage and a load modulation includes a first step S1 of applying a load modulation signal 322 to a control input of means 310 with a resistance controllable by a control signal at the control input thereof. In a second step S2, a voltage limitation control signal 332 is applied to the control input of the means 310.

Summarizing, the inventive concept described based on FIGS. 3 to 7 allows a limitation of the supply voltage U₂ of a transponder and the simultaneous load modulation by switching a modulation resistor R_{mod} with only one transistor means. The inventive concept allows saving critical chip area for RFID chips that are becoming smaller and smaller, which achieves a reduction of costs.

Thus, embodiments of the present invention have the advantage that a voltage limitation of a supply voltage induced at the transponder oscillating circuit and a load modulation may be done via only one transistor. This allows saving chip area, for example for an RFID chip.

Finally, it is to be noted that the inventive concept is not limited to RFID technology. The present invention may equally be applied to technologies other than those described here by way of example.

In particular, it is to be noted that, depending on the circumstances, the inventive scheme may also be implemented in software. The implementation may be done on a digital storage medium, particularly a floppy disk or a CD with electronically readable control signals, which may cooperate with a programmable computer system and/or microcontroller so that the corresponding method is performed. In general, the invention thus also consists in a computer program product with a program code stored on a machine-readable carrier for performing the inventive method when the computer program product runs on a computer and/or microcontroller. In other words, the invention may thus be realized as a computer program with a program code for performing the method when the computer program runs on a computer and/or microcontroller.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A transponder circuit comprising:
a transmission/reception coil;
an integrated circuit coupled to the transmission/reception coil and comprising an output for a modulation signal;
a transistor coupled to the transmission/reception coil and comprising a control input coupled to the output for the modulation signal; and
a voltage limitation control circuit coupled to the transmission/reception coil and comprising an output for a voltage limitation control signal coupled to the control input of the transistor.

2. The transponder circuit of claim 1 additionally comprising a voltage rectifier circuit coupled to the transmission/reception coil.

3. The transponder circuit of claim 2, wherein the transistor, the voltage limitation control circuit and the rectifier circuit are connected in parallel.

4. The transponder circuit of claim 1, wherein the controllable transistor resistance contributes to a transponder transmission/reception oscillating circuit, and a supply voltage is kept in a predefined range by the voltage limitation control signal.

5. The transponder circuit of claim 1, wherein the transponder is an RFID transponder.

6. The transponder circuit of claim 1, wherein the voltage limitation control signal comprises a larger time constant than the modulation signal.

7. The transponder circuit of claim 1, wherein the voltage limitation control circuit comprises a Zener diode.

8. A device for providing a supply voltage and a load modulation in a transponder, comprising:
means having a resistance controllable by a control signal at a control input thereof;
means for applying a load modulation signal to the control input; and
means for applying a voltage limitation control signal to the control input.

9. The device of claim 8, wherein the means having the controllable resistance comprises a transistor.

10. The device of claim 8, wherein the means for applying the load modulation signal comprises an integrated digital logic circuit.

11. The device of claim 8, wherein the device further comprises means for rectifying the supply voltage.

12. The device of claim 8, wherein the controllable resistance contributes to a transponder transmission/reception oscillating circuit, and the supply voltage is kept in a predefined range by the voltage limitation control signal.

13. The device of claim 8, wherein the transponder is an RFID transponder.

14. A device for providing a supply voltage and a load modulation in a transponder comprising a transistor to the control input of which a voltage limitation control signal and a load modulation signal are applied.

15. The device of claim 14, wherein the device comprises a regulating circuit for providing the voltage limitation control signal and a circuit for controlling the modulation signal.

16. The device of claim 15, wherein a quality of a transponder oscillating circuit may be adjusted with the regulating circuit such that the supply voltage remains at least approximately constant.

17. The device of claim 14, wherein the transponder is an RFID transponder.

18. A method for providing a supply voltage and a load modulation in a transponder, comprising:
applying a load modulation signal to a control input of a unit having a resistance controllable by a control signal at the control input thereof; and
applying a voltage limitation control signal to the control input.

19. The method of claim 18, wherein the step of applying the load modulation signal and the step of applying the voltage limitation control signal each include applying the signals to a control terminal of a transistor.

20. The method of claim 18, wherein, in the step of applying the load modulation signal, the load modulation signal originates from an integrated digital logic circuit.

21. The method of claim 18, further comprising a step of rectifying the supply voltage.

22. The method of claim 18, wherein the supply voltage is kept in a predefined range by controlling the controllable resistance by the voltage limitation control signal.

23. The method of claim 18, wherein the transponder is an RFID transponder.

24. A computer program comprising a program code for performing a method for providing a supply voltage and a load modulation in a transponder, when the computer program runs on a computer and/or microcontroller, the method comprising applying a load modulation signal to a control input of a unit having a resistance controllable by a control signal at the control input thereof; and applying a voltage limitation control signal to the control input.
